(19) United States
(12) Patent Application Publication
(10) Pub. No.: US 2008/0218083 A1
(43) Pub. Date: Sep. 11, 2008

(54) Lamp Assembly Comprising a Reflector and a Method for Manufacturing the Lamp Assembly

(75) Inventors: Godefridus Cornelis Goverde, Turnhout (BE); Constant Daems, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/066,532

(22) PCT Filed: Sep. 7, 2006
(86) PCT No.: PCT/IB2006/053149

§ 371 Date: Mar. 12, 2008

(30) Foreign Application Priority Data
Sep. 13, 2005 (EP) 05108391.3

(51) Int. Cl. H01J 17/30; H01J 9/02

(52) U.S. Cl. 313/634; 445/27

(57) ABSTRACT

A method for manufacturing a high-pressure gas discharge lamp assembly comprising a burner (3) and a reflector (1). The burner (3) is fixed to the reflector (1) such that at least a part of the concave light reflecting surface (2) of the reflector (1) surrounds the light emitting part of the burner (3). An end portion (11) of the glass bulb of the burner (3) is embedded in cement (15) in order to fix it in a central hole of the reflector (1). The end portion (11) of the glass bulb of the burner (3) is attached by means of cement (15) to a metal holder (14), and afterwards the metal holder (14) is attached to the reflector (1).

The invention is related to a method for manufacturing a high-pressure gas discharge lamp assembly comprising a burner and a reflector, in which the burner is fixed to the reflector so that at least a part of the concave light reflecting surface of the reflector surrounds the light emitting part of the burner, an end portion of the glass bulb of the burner being embedded in cement in order to fix it in a central hole of the reflector.

It is usual to fix the bulb of the burner in the reflector by means of cement, because the cement is an appropriate material to seal very tightly the glass material of the bulb. Furthermore, the cement can withstand the high temperatures inside the lamp assembly when the lamp assembly is in use. The bulb of the burner may have one or two end portions at opposite ends of the glass bulb, whereby the bulb is sealed at the two end portions in order to close it. Such end portion is sealed by the cement in the central hole of the reflector, so that the light emitting part of the burner is surrounded by the concave light reflecting surface of the reflector.

A high-pressure gas discharge lamp assembly as described above is disclosed in WO-A-2005/055272. The light source in such lamp assembly, i.e. the light emitting part of the burner, has to be accurately positioned at a predetermined position with respect to the concave light reflecting surface of the reflector in order to produce an appropriate light beam. A relative small deviation from that predetermined position results in an unacceptably low quality of the lamp assembly. Therefore, the glass bulb of the burner is fixed to the reflector while the burner is kept in the correct position with respect to the reflector, and that correct position is dependent from the exact location of the light source (i.e. the gas discharge) in the burner.

The correct position of the burner can be determined by supplying electric power to the burner while it is movably kept inside the space surrounded by the reflector, whereby the reflected light beam is measured. The burner can be moved till the desired light beam is detected. Then the burner has to be switched off and cooled down while the burner is kept in the correct position. After cooling down the cement can be applied, in order the fix the burner in the correct position in the central hole of the reflector. After the cement is applied, the cement hardens during a period of time, which period is relatively long, in general more than one minute. During that time the burner has to be kept in its position. So, the fixation of the burner in the central hole of the reflector is a complex and time consuming operation.

An object of the invention is a method for manufacturing a high-pressure gas discharge lamp assembly comprising a burner and a reflector, in which the fixation of the burner in the central hole of the reflector can be performed in a relative short period of time.

To realize this object, the end portion of the glass bulb of the burner is attached by means of cement to a metal holder, the metal holder being attached to the reflector afterwards. For example, the metal holder can be attached to the reflector by clamping, but preferably, the metal holder is attached to the reflector by means of a welding operation. Because cement is used to seal the end portion of the glass bulb of the burner, there is a tight and reliable seal of the burner. The application of the cement and the hardening of the cement can take place separately from the operation whereby the burner is fixed in its correct position in the space surrounded by the reflector. Furthermore, the positioning of the burner with respect to the metal holder is not critical.

The fixation of the metal holder with the burner in the space surrounded by the reflector can take place at the moment that the burner is brought in its correct position with respect to the reflector. Furthermore, the fixation operation can be performed in a short period of time. There is no need to cool down the lamp assembly after burning the burner, whereby the correct position of the burner is determined, because the fixation operation can take place at a high temperature of the lamp assembly.

In a preferred embodiment, the reflector is provided with a metal member, whereby the metal holder is attached to the reflector by a welding operation when the burner is held in its desired position (said correct position) with respect to the reflector. The metal member can be glued, cemented or clamped to the reflector, and the metal holder can be connected to the metal member through an intermediate member. But preferably, the metal holder is welded directly to the metal member when the burner is held in its desired position with respect to the reflector. Such welding operation can be performed by means of a laser beam, and can take place in a very short period of time.

The invention is furthermore related to a high-pressure gas discharge lamp assembly comprising a burner and a reflector, in which the burner is fixed to the reflector so that at least a part of the concave light reflecting surface of the reflector surrounds the light emitting part of the burner, an end portion of the glass bulb of the burner being embedded in cement in order to fix it in a central hole of the reflector, said cement connecting the end portion of the glass bulb with a metal holder, and the metal holder being attached to the reflector.

In a preferred embodiment, the reflector is provided with a metal member, to which metal member the metal holder is welded through an intermediate member, or preferably, directly without an intermediate member. The metal member can be glued or cemented to the reflector, but preferably, the metal member is clamped against the reflector.

Preferably, the metal holder comprises a tube-like portion surrounding the end portion of the glass bulb of the burner, such that there can be a firm seal between the glass bulb of the burner and the metal holder.

In a preferred embodiment, one of the wires for supplying electric power to the burner is connected to a part of the metal holder reaching inside the space surrounded by the reflector, whereby electric current is supplied through the metal holder. In case the two wires for supplying electric current to the burner are connected with the burner through two opposite sealed end portions of the glass bulb, one wire can leave the glass bulb at the back side of the reflector, while the other wire leaves the glass bulb through the other end portion inside the space surrounded by the reflector. By connecting that wire with the part of the metal holder that reaches inside the space surrounded by the reflector, another part of the metal holder reaching outside the reflector (at the back side of the reflector) can be connected to the means for supplying electric power to the burner. So, there is no need for an additional hole in the reflector for accommodating an electric wire.

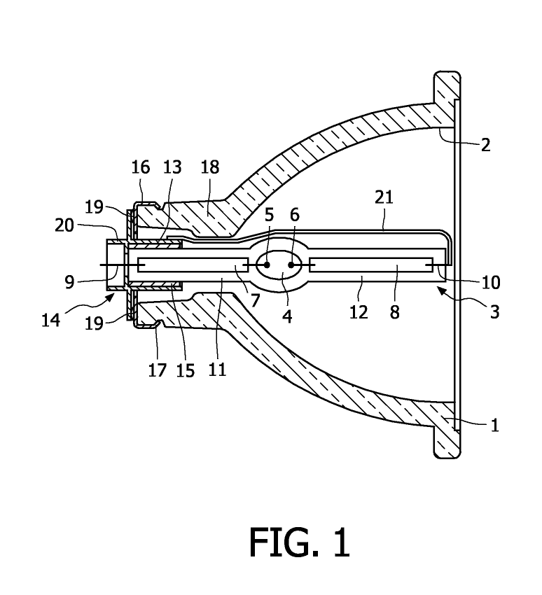

The invention will now be further elucidated by means of a description of a lamp assembly, comprising a high-pressure gas discharge lamp and a reflector, in which a part of the concave light reflecting surface of the reflector surrounds the light emitting part of the burner. Reference is made to the drawing comprising one FIGURE (FIG. 1) showing a sectional view of the lamp assembly.

FIG. 1 shows the lamp assembly comprising a reflector 1 mainly made of glass (glass, glass-ceramic or quartz), which reflector 1 is bell-shaped and is shown in a sectional view, its central axis being in the plane of the drawing. The reflector 1 is provided with a light reflecting coating 2 on its parabolic-shaped (or elliptic) inner surface. A high-pressure gas discharge burner 3 is present inside the space surrounded by the reflector 1, so that the light source in the gas discharge space 4 of the glass bulb of the burner 3 is located at or near the focus point of the parabolic (or elliptic) shape. Inside the gas discharge space 4 are two electrodes 5,6, each being electrically connected through a molybdenum foil 7,8 with electric current supply wires 9,10. Each molybdenum foil 7,8 is located in a sealed end portion 11,12 of the bulb of the burner 3, the two sealed end portions 11,12 extending outwardly in opposite directions, substantially along the central axis of the reflector 1.

The burner 3 is attached to the reflector 1 through one of the sealed end portions, which sealed end portion 11 is fixed in a tubular part 13 of a metal holder 14, where it is embedded in cement 15 that is present between the cylindrical wall of the tubular part 13 of the metal holder 14 and the sealed end portion 11 of the bulb of the burner 3. The metal holder 14 is welded to a metal member 16, which metal member 16 is attached to the reflector 1 by clamping, whereby the edge 17 of the metal member 16 is forced into an annular groove in the neck portion 18 of the reflector 1. The welded joints 19 between the metal holder 14 and the metal member 16 provide for a non-detachable and solid connection between the reflector 1 and the metal holder 14, and the cement 15 provides for a non-detachable and solid connection between the metal holder 14 and the burner 3. Therefore, the burner 3 is firmly fixed in the space surrounded by the reflector 1 of the lamp assembly.

In general, the lamp assembly must produce a specified light beam. Therefore, the light source in the discharge space 4 must have an exact predetermined position inside the concave light reflecting surface 2 of the reflector 1. An appropriate method for fixing the burner 3 to the reflector 1, in which the light source is precisely positioned at the predetermined location inside the space surrounded by the reflector 1, may comprise the following four steps.

The first step is connecting the metal holder 14 to the sealed end portion 11 of the glass bulb of the burner 3. Cement 15 is applied between the wall of the tubular part 13 of the metal holder 14 and the sealed end portion 11, after the sealed end portion 11 is inserted in the tubular part 13. The second step is providing the reflector 1 with the metal member 16 by forcing the edge 17 of the metal member 16 into a groove in the neck portion 18 of the reflector 1 (see FIG. 1).

The third step is to place the burner 3 in the correct position inside the space surrounded by the reflector 1, whereby the light source of the burner 3 is present in the predetermined position with respect to the light reflecting inner surface 2 of the reflector 1. The burner 3 can be engaged through a second tubular part 20 of the metal holder 14 in order to move it to its correct position. The correct position can be found by switching on the burner, so that a light beam is produced by the reflector 1. The light beam can be measured, and the burner can be moved till the desired light beam, according to the specification of it, is detected. At that moment the fourth step can take place, being the welding operation whereby the metal holder 14 is welded to the metal member 16 by means of welded joints 19.

As an alternative, there may be an intermediate member (also a metal element) that is welded to the metal holder 14 and is also welded to the metal member 16. Thereby, the metal holder 14 can be fixed to the metal member 16 in more different positions with respect to each other.

The wire 9 for supplying electric current to electrode 5 leaves the bulb of burner 3 through sealed end portion 11, so that the end of wire 9 is located behind the reflector 1 (at the back side of the reflector 1), and can be connected with electric power supply means (not shown in the FIGURE). The wire 10 for supplying electric current to electrode 6 leaves the bulb through the other sealed end portion 12 inside the space surrounded by the reflector 1. Wire 10 is connected with the tubular part 13 of metal holder 14 through wire 21, so that electric power can be supplied to electrode 6 through metal holder 14, and the electric power supply means can be connected to the second tubular part 20 of metal holder 14, which part 20 extends behind the reflector 1 (at the back side of the reflector 1).

The embodiment as described above is merely an example of a lamp assembly according to the invention; many other embodiments are possible.

### REFERENCES

1 reflector
2 reflecting coating
3 burner
4 gas discharge space
5 electrode
6 electrode
7 conductive molybdenum foil
8 conductive molybdenum foil
9 electric current supply wire
10 electric current supply wire
11 sealed end portion of burner
12 sealed end portion of burner
13 tubular part of metal holder 14
14 metal holder
15 cement
16 metal member
17 edge of metal member 16
18 neck portion of reflector 1
19 welded joints
20 second tubular part of metal holder 14
21 electric current wire

1. A method for manufacturing a high-pressure gas discharge lamp assembly comprising a burner (3) and a reflector (1), in which the burner (3) is fixed to the reflector (1) such that at least a part of the concave light reflecting surface (2) of the reflector (1) surrounds the light emitting part of the burner (3), an end portion (11) of the glass bulb of the burner (3) being embedded in cement (15) in order to fix it in a central hole of the reflector (1), characterized in that the end portion (11) of the glass bulb of the burner (3) is attached by means of cement (15) to a metal holder (14), and in that afterwards the metal holder (14) is attached to the reflector (1).

2. A method as claimed in claim 1, characterized in that the reflector (1) is provided with a metal member (16) and in that the metal holder (14) is attached to the reflector (1) by a welding operation when the burner (3) is held in its desired position with respect to the reflector (1).

3. A method as claimed in claim 2, characterized in that the metal holder (14) is welded to the metal member (16) when the burner (3) is held in its desired position with respect to the reflector (1).

4. A high-pressure gas discharge lamp assembly comprising a burner (3) and a reflector (1), in which the burner (3) is fixed to the reflector (1) so that at least a part of the concave light reflecting surface (2) of the reflector (1) surrounds the light emitting part of the burner (3), an end portion (11) of the glass bulb of the burner (3) being embedded in cement (15) in order to fix it in a central hole of the reflector (1), characterized in that said cement (15) connects the end portion (11) of the glass bulb with a metal holder (14), and in that the metal holder (14) is attached to the reflector (1).

5. A lamp assembly as claimed in claim 4, characterized in that the reflector (1) is provided with a metal member (16), to which metal member (16) the metal holder (14) is welded.

6. A lamp assembly as claimed in claim 5, characterized in that said metal member (16) is clamped against the reflector (1).

7. A lamp assembly as claimed in claim 4, characterized in that the metal holder (14) comprises a tube-like (13) portion surrounding the end portion (11) of the glass bulb of the burner (3).

8. A lamp assembly as claimed claim 4, characterized in that one of the wires (21) for supplying electric power to the burner (3) is connected to a part of the metal holder (14) reaching inside the space surrounded by the reflector (1), whereby electric current is supplied through the metal holder (14).

9. A high-pressure gas discharge lamp assembly comprising a burner (3) whereby two wires for supplying electric current to the burner are connected with the burner through two opposite sealed end portions of the burner, and a reflector (1), in which the burner (3) is fixed to the reflector (1) so that at least a part of the concave light reflecting surface (2) of the reflector (1) surrounds the light emitting part of the burner (3), an end portion (11) of the burner (3) being embedded in cement (15) in order to fix it in a central hole of the reflector (1), whereby said cement (15) connects the end portion (11) of the burner (3) with a metal holder (14), and whereby the metal holder (14) is attached to the reflector (1), characterized in that one of the wires (21) for supplying electric power to the burner (3) is connected to a part of the metal holder (14) reaching inside the space surrounded by the reflector (1), whereby electric current is supplied through the metal holder (14).
